(19) United States
(12) Patent Application Publication
(10) Pub. No.: US 2010/0209633 A1
(43) Pub. Date: Aug. 19, 2010

(54) CURVED TEST SPECIMEN

(75) Inventors: Daniel Greving, Scottsdale, AZ (US); Brian Hann, Avondale, AZ (US); Jack McIver, Mesa, AZ (US); Nagaraja Rudrapatna, Chandler, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/372,262

(22) Filed: Feb. 17, 2009

(51) Int. Cl. B32B 1/08; B05D 3/12; B05D 3/06; B05D 1/08

(52) U.S. Cl. 428/34.1; 427/327; 427/554; 427/446

(57) ABSTRACT

A cylindrical test specimen is provided. The test specimen comprises a metallic sheet curved to form a cylindrical shape, an adhesive layer contacting the metallic sheet, and a thermal barrier coating coupled to the metallic sheet with the adhesive layer, the thermal barrier coating adapted to inhibit thermal transfer.

### TECHNICAL FIELD

Embodiments of the subject matter described herein relate generally to combustors. More particularly, embodiments of the subject matter relate to a realistic specimen shape for testing combustor component properties.

### BACKGROUND

High performance components, such as those for jet engines, operate in high temperature and high pressure environments. Particularly in combustion chambers of high-performance engines, components are required to retain certain mechanical properties. While certain effects of the environment can be predicted, real world operating conditions can be difficult to model. Thus, the designs of components for such systems require testing prior to widespread adoption.

For example, the interior of a combustion chamber can have an uneven operating temperature. Not only does combustible fuel ignite at different rates in certain regions of the combustion chamber because of the chamber's geometry, variations in concentration of fuel can cause certain regions of the chamber to experience higher temperatures than other regions. Accordingly, the combustor components which enclose the combustion chamber can experience thermal “hot spots” or regions of concentrated heat exceeding the average temperature of the chamber.

Current testing methods for combustor components are unsophisticated as compared to the complex environment in which they will perform. A standard component sample test involves exposing a flat segment of the component's material to a uniform temperature to predict its result. This type of test specimen is inadequate because it fails to model strains that can arise when a small region experiences a significantly greater heat than the rest of the component. Additionally, a combustor component can be formed of a variety of elements. Typically, each element is tested separately. The results from each element are then used to predict the performance of the combination. This can result in inaccurate predictions because of interactions between the elements which do not manifest in separate testing.

### BRIEF SUMMARY

A cylindrical test specimen is provided. The test specimen comprises a metallic sheet curved to form a cylindrical shape, an adhesive layer contacting the metallic sheet, and a thermal barrier coating coupled to the metallic sheet with the adhesive layer, the thermal barrier coating adapted to inhibit thermal transfer.

A test sample is also provided. The test specimen comprises a metal sheet formed in a open-ended tube, the metal sheet having an outer surface, an adhesive layer on the outer surface, and a thermal coating coupled to the metal sheet with the adhesive layer.

A method of forming a test specimen is also provided. The method comprises applying a thermal coating to a metal sheet, the metal sheet having a first side, a first end, and a second end, bending the metal sheet into a cylindrical shape by positioning the first end proximate the second end, the first side on an outer surface of the cylindrical shape, and welding the first and second ends together.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of an embodiment of a test specimen;

FIG. 2 is a cross-sectional view of the test specimen of FIG. 1, as viewed from line 2-2; and

FIG. 3 is a flowchart illustrating a method of forming an embodiment of a test specimen.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

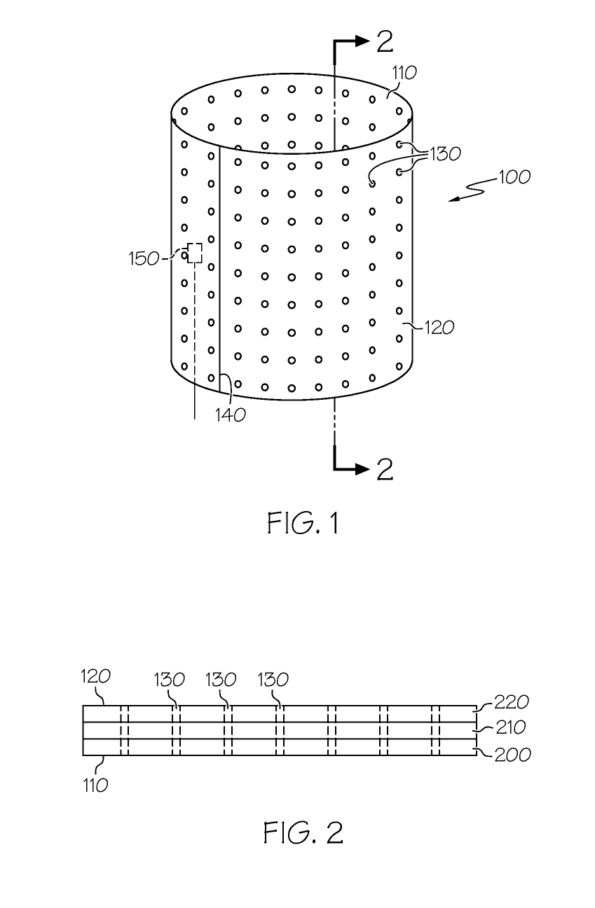

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

One improvement that can be made to better simulate actual operational conditions for a component is to form the individual elements of the component into a single unit. Preferably, the single unit captures as many aspects of the actual component as possible, including curvature, welds, designed ports, and so on.

FIG. 1 illustrates an embodiment of a test sample or test specimen 100 having a substantially cylindrical shape. The test specimen 100 is preferably of a size and shape useful for testing in a heating apparatus. The illustrated embodiment is used for descriptive purposes only, and does not reflect an exact scale, size, or proportion. The test specimen 100 preferably has a curved shape, and while a cylindrical shape is shown, other shapes can be used, such as an elliptical cylinder, an irregularly-curved cylinder, an octagonal cylinder, and so on. The curved shape can be formed by a metal sheet having a curve, as described below. Thus, the test specimen 100 can be an open-ended tube having any desired curvature in cross-section.

The test specimen 100 has an inner surface 110 and an outer surface 120. The test specimen 100 can have a plurality of holes 130 extending through it. The holes 130 can be used to permit a fluid to flow from the inside of the test specimen 100 to the outside during test operations. For example, a cooling gas can be introduced to the inside of the test specimen 100, which can effuse through the holes 130. The pressure of the cooling gas can be adjusted to permit or inhibit flow into the holes 130, as desired. Other fluids, including various gases and liquids, can pass through the holes 130 as well.

The inner surface 110, which represents the inside of the test specimen 100, is preferably a surface of a metallic sheet, while the outer surface 120 is preferably a thermal barrier coating, both of which are described in greater detail below. The metallic sheet and other components can be formed into the curved shape by bending. Thereafter, the shape can be fixed via welding. Accordingly, a weld portion 140 is also present, extending lengthwise or in any orientation along the test specimen 100. In certain embodiments, a sensor 150 can be affixed, fastened, or otherwise coupled to the inner surface 110 (for reasons described in more detail below).

In addition to the illustrated features, the test sample or test specimen 100 can comprise additional features, such as flanges, fasteners, fastener receivers, ports, and so on, for coupling with other devices and/or components. Thus, although not shown, additional features are contemplated and can be present without deviating from the intended structure of the illustrated embodiment.

Reference is additionally made to FIG. 2, which illustrates a cross-sectional view of the test specimen 100, for description the features of the embodiment shown in FIG. 1. The composition of the test specimen 100 as a plurality of layers is clearly visible. The inner surface 110 is a surface of a metallic or metal sheet 200. The metal sheet 200 can serve as the base of the test specimen 100, and preferably is formed from a flat shape. Thus, in the illustrated embodiment, the metal sheet 200 preferably has a first end and a second end, the two ends coupled or joined by the weld portion 140. The metal sheet 200 has two sides, the first side forming the inner surface 110 of the test specimen 100, and the second side receiving an adhesive layer 210.

The metal sheet 200 preferably is composed of the same material as will be used for the actual combustor component which it is modeling. Thus, the metal sheet 200 preferably comprises a superalloy, such as a nickel- or cobalt-based superalloy. Some sample materials can include HAYNES® superalloys, such as HASTELLOY® materials, INCONEL® materials, and so on. The metal sheet 200 preferably has a thickness between 0.01″ and 0.10″, including 0.05″, though any thickness appropriate to the embodiment can be used. Preferably, the metal sheet 200 has a thickness approximately equal to the thickness for the proposed combustor component being tested.

An adhesive layer 210 can be disposed on or against the metal sheet 200. The adhesive layer 210 is preferably composed of a bonding material adapted to adhere to the metal sheet 200, as well as couple the thermal coating 220 to the metal sheet 200. Accordingly, the adhesive layer 210 can be composed of any suitable bonding agent. Some sample materials which can compose the adhesive layer are NiCrAlY and CoNiCrAlY, although others can also be used. The thickness of the adhesive layer 210 is preferably between 0.001″ and 0.010″, though any thickness appropriate to perform the described functions is contemplated.

The thermal coating 220 is a layer disposed atop the adhesive layer 210. The thermal coating 220 is preferably affixed to the metal sheet 200 by the adhesive layer 210. Preferably, the thermal coating 220 inhibits heat or thermal transfer through itself, thereby acting as an insulator. The thermal coating 220 can be any type of thermal barrier coating used in combustor components, such as ceramic-based thermal insulators. In particular, the thermal coating 220 may include any of the following materials, without limitation: yittria stabilized zirconia as a monolayer, or multilayer variations of different yittria percentages. The thickness of the thermal coating 220 can be between 0.001″ and 0.050″, including 0.010″. The thickness of the thermal coating 220 is preferably selected to resemble the thickness of a thermal barrier coating on the combustor component being tested.

The plurality of holes 130 can extend through the thermal coating 220, adhesive layer 210, and metal sheet 200, as shown. The holes 130 can be drilled or formed by any appropriate technique, including a laser drilling technique. Preferably, the holes 130 are formed after the layers have been formed into a sandwich construction. The exact number, shape, orientation, and size of holes 130 can vary between embodiments, and certain embodiments of the test specimen 100 do not have any holes extending through the layers. Preferably, the holes 130 do not extend through the weld portion 140, although they can in certain embodiments.

The sensor 150 can be affixed to the inner surface 110 at any desired location. The sensor 150 can be affixed using a fastener, such as a bolt, a weld, an adhesive, such as epoxy or other temporary or permanent bonding agent, mechanical techniques, such as an interference fit with features of the test specimen 100, or any other method or technique appropriate to the embodiment. Although shown in one position, the sensor 150 can be placed in other positions as well, without limitation. Additionally, the sensor 150 can be of various types, depending on the information desired. For example, the sensor 150 can be embodied as a thermocouple, a strain sensor, and so on. The sensor 150 can be embodied as either a complete sensing instrument, or as a detection portion of a sensing instrument. The location at which the sensor 150 contacts the inner surface 110 is referred to as a coupling site and simply denotes a specific position. Preferably, the sensor 150 is used to monitor conditions at the coupling site during test of the test specimen 100. Thus, where a thermocouple is used, the sensor 150 can detect the temperature at the coupling site during test conditions. Similarly, a strain gauge can be used to detect strains in the test specimen 100 at the coupling site, and so on.

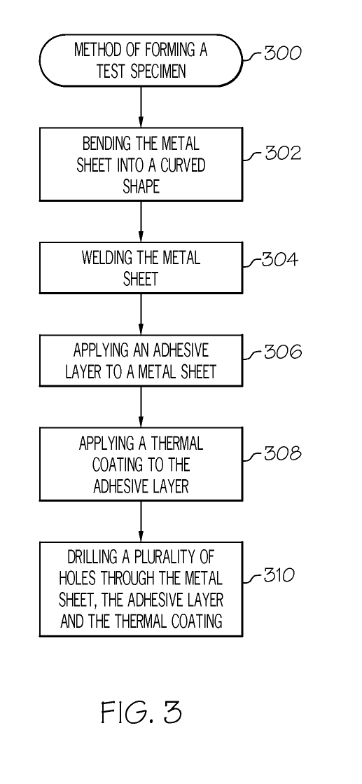

FIG. 3 illustrates a method 300 of forming a test specimen, such as the one described above. For illustrative purposes, the following description of method 300 may refer to elements mentioned above in connection with FIGS. 1 and 2. It should be appreciated that method 300 may include any number of additional or alternative tasks, the tasks shown in FIG. 3 need not be performed in the illustrated order, and method 300 may be incorporated into a more comprehensive procedure or process having additional functionality not described in detail herein.

To form the test specimen 100, a sheet of the selected metal is first bent or worked to form the desired curved shape (task 302). When bending, first and second ends of the metal sheet 200 can be positioned proximate each other, such as occurs in rolling a sheet. A weld is then applied to form the weld portion 140 (task 304). Although welding is used for descriptive purposes, any other coupling technique can be used to form the metal sheet 200 into the shape desired for the test specimen 100. Preferably, the technique for affixing, coupling, sealing, or otherwise joining the first and second ends of the metal sheet 200 is similar or the same as one to be used to form the combustor component the test specimen 100 models.

An adhesive layer 210 is then applied to the outer surface of the metal sheet 200 (task 306). The application or affixation can include any appropriate technique, such as rolling, spraying, vapor deposition, or any other method. If appropriate to the affixation of the adhesive layer 210, other steps can occur, including curing, drying, or exposure to additional materials necessary to complete the application of the adhesive layer 210. Subsequently, the thermal coating 220 is disposed against the adhesive layer 210 (task 308). The thermal coating 220 can be introduced any of a variety of ways, such as through a thermal spray process. Other processes and techniques can be used, as appropriate to the embodiment. For example, in some embodiments, the thermal coating 220 can be applied as a solid sheet, whereas in others, it can be applied in a liquid state, and subsequently solidified. Thus, task 304 can include other steps necessary to apply the thermal coating 220 as appropriate to the embodiment. Optionally, after the thermal coating 220 is applied, the plurality of holes 130 can be formed, such as through a laser drilling process (task 310).

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A cylindrical test specimen comprising:
a metallic sheet curved to form a cylindrical shape;
an adhesive layer contacting the metallic sheet; and
a thermal barrier coating coupled to the metallic sheet with the adhesive layer, the thermal barrier coating adapted to inhibit thermal transfer.

2. The test specimen of claim 1, wherein the metallic sheet comprises a superalloy.

3. The test specimen of claim 2, wherein the superalloy comprises a nickel-based superalloy.

4. The test specimen of claim 2, wherein the superalloy comprises a cobalt-based superalloy.

5. The test specimen of claim 1, wherein the metallic sheet has a first end and a second end, and the cylindrical shape is formed by positioning the first end proximate the second end.

6. The test specimen of claim 5, further comprising a weld portion adapted to couple the first and second ends.

7. The test specimen of claim 1, further comprising a sensor coupled to the metallic sheet at a coupling site, the sensor adapted to sense a temperature at the coupling site.

8. The test specimen of claim 7, wherein the sensor comprises a thermocouple.

9. A test sample comprising:
a metal sheet formed in a open-ended tube, the metal sheet having an outer surface;
an adhesive layer on the outer surface; and
a thermal coating coupled to the metal sheet with the adhesive layer.

10. The test sample of claim 9, wherein the metal sheet has a first end and a second end, and the curve is formed by positioning the first end proximate the second end.

11. The test sample of claim 10, wherein the first end is coupled to the second end by a weld.

12. The test sample of claim 9, further comprising a plurality of holes extending through the thermal coating, the adhesive layer, and the metal sheet.

13. The test sample of claim 12, wherein the plurality of holes are formed by laser drilling.

14. The test sample of claim 9, wherein the metal sheet has a thickness of approximately 0.05 inches.

15. The test sample of claim 9, wherein the thermal coating has a thickness of approximately 0.01 inches.

16. A method of forming a test specimen comprising:
bending a metal sheet having a first side, a first end, and a second end into a cylindrical shape by positioning the first end proximate the second end, the first side on an outside surface of the cylindrical shape;
welding the first and second ends together; and
applying a thermal coating to the first side of the metal sheet.

17. The method of claim 16, wherein the metal sheet has a second side, the second side on the inside of the cylindrical shape, and the method further comprising coupling a sensor to the second side of the metal sheet.

18. The method of claim 16, further comprising forming a plurality of holes, each of the plurality of holes extending through the thermal coating, the adhesive layer, and the metal sheet, each of the plurality of holes adapted to permit a fluid to flow therethrough.

19. The method of claim 18, wherein forming the plurality of holes comprises drilling the plurality of holes with a laser.

20. The method of claim 16, wherein applying the thermal coating comprises applying the thermal coating with a thermal spray process.
